(19) United States
(12) Patent Application Publication
(10) Pub. No.: US 2004/0264223 A1
(43) Pub. Date: Dec. 30, 2004

(54) Switched capacitor power converter

(75) Inventors: Nathan L. Pihlstrom, Colorado Springs, CO (US); Jon E. Tourville, Colorado Springs, CO (US)

Correspondence Address: LeMoine Patent Services PLLC, c/o PortfolioIP, P.O. Box 52050, Minneapolis, MN, 55402, US

(73) Assignee: Intel Corporation

(21) Appl. No.: 10/609,787

(22) Filed: Jun. 30, 2003

(51) Int. Cl. H02M 5/42

(52) U.S. Cl. 363/89

(57) ABSTRACT

A switched-capacitor power converter includes capacitive elements and switching elements configurable to provide a non-integer step-up or non-integer step-down voltage conversion.

### FIELD

The present invention relates generally to power conversion circuits, and more specifically to switched-capacitor power conversion circuits.

### BACKGROUND

Power conversion circuits typically convert power usable in a first form to a second form. For example, power conversion circuits such as a linear regulators and switched-capacitor converters can receive power at one voltage, and deliver power at another voltage. Linear regulators are typically not as efficient as switched-capacitor converters. Switched-capacitor converters use capacitors as energy storage/transfer elements and are commonly used when higher efficiencies than a linear regulator are desired.

A switched-capacitor converter typically has two operational phases: a charging phase; and a discharging phase. FIGS. 1 and 2 show a prior art switched-capacitor step down or bucking converter. Capacitors 116 and 114 are coupled differently by switches 120, 106, 108, and 110 during the two phases. The charging phase is shown in FIG. 1 with capacitors 116 and 114 coupled in series between input node 102 and reference node 112. Each capacitor has an equal capacitance value and is charged to V_{IN}/2 during the charging phase. The discharging phase is shown in FIG. 2 with capacitors 116 and 114 coupled in parallel between output node 104 and reference node 112. The output voltage V_{OUT}=V_{IN}/2.

FIGS. 1 and 2 show a circuit having a two-to-one voltage reduction using two capacitors. A three-to-one reduction may be produced using three capacitors. Similar to the two-to-one converter, the three-to-one converter stacks the three capacitors with equal capacitance values in series during the charging phase and places them in parallel during the discharging phase. Circuits of the type shown in FIGS. 1 and 2 have an output voltage range given by V_{IN}/n where n is the number of capacitors placed in series.

### BRIEF DESCRIPTION OF THE DRAWINGS

FIGS. 1 and 2 show a prior art switched-capacitor converter;

FIG. 3 shows a switched-capacitor converter in a step-down charging phase;

FIG. 4 shows a switched-capacitor converter in a step-down discharging phase;

FIG. 5 shows a switched-capacitor converter in a step-up charging phase;

FIG. 6 shows a switched-capacitor converter in a step-up discharging phase;

FIG. 7 shows a diagram of a switched-capacitor power converter;

FIG. 8 shows a system diagram in accordance with various embodiments of the present invention; and

FIG. 9 shows a flowchart in accordance with various embodiments of the present invention.

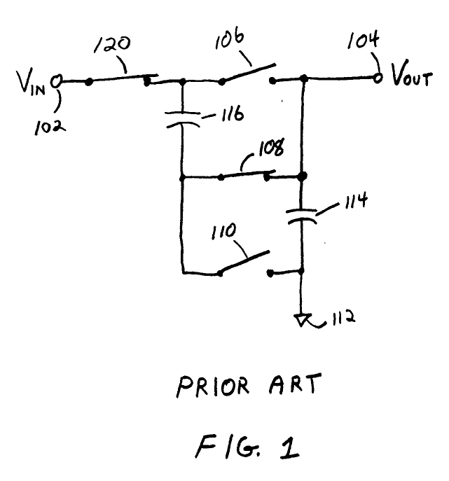

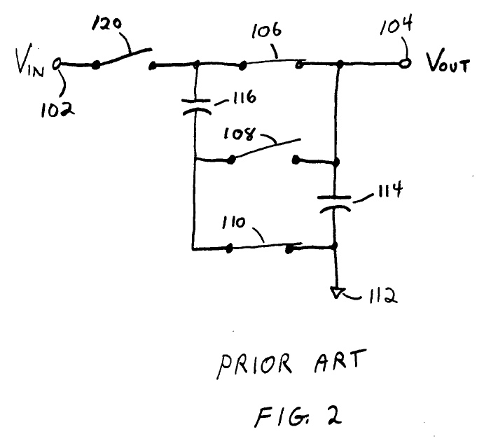

### DESCRIPTION OF EMBODIMENTS

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. For example, a particular feature, structure, or characteristic described herein in connection with one embodiment may be implemented within other embodiments without departing from the spirit and scope of the invention. In addition, it is to be understood that the location or arrangement of individual elements within each disclosed embodiment may be modified without departing from the spirit and scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

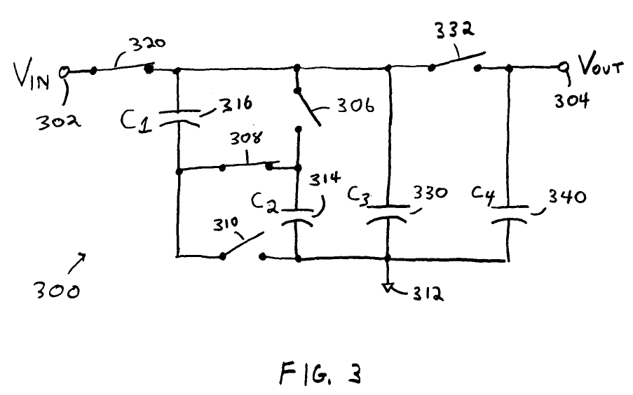

FIG. 3 shows a switched-capacitor converter in a step-down charging phase. Switched-capacitor power converter 300 includes capacitors 316, 314, 330, and 340, and switches 320, 306, 308, 310, and 332. During the charging phase shown in FIG. 3, capacitors 316 and 314 are coupled in series between input node 302 and reference node 312, and each of capacitors 316 and 314 charges to a voltage less than V_{IN}. Capacitor 330 is coupled in parallel with the series combination of capacitors 316 and 314, and charges to V_{IN}. Capacitor 340 is an output capacitor that is electrically isolated from the other capacitors by switch 332 during the charging phase.

A capacitor with voltage V placed across it will charge to V. When n capacitors of equal capacitance are placed in series across a voltage V, each capacitor charges to V/n. The amount of charge stored in each capacitor is given by Q=CV/n where n is equal to or greater than 1, and C is the capacitance value of the capacitor. As shown in FIG. 3, capacitor 316 has a capacitance value of C₁, capacitor 314 has a capacitance value of C₂, capacitor 330 has a capacitance value of C₃, and capacitor 340 has a capacitance value of C₄. Accordingly, for embodiments in which C₁ and C₂ are equal, during the charging phase shown in FIG. 3, capacitor 316 stores a charge of C₁V_{IN}/2, capacitor 314 stores a charge of C₂V_{IN}/2, and capacitor 330 stores a charge of C₃V_{IN}. The total charge stored on capacitors 316, 314, and 330 is equal to C₁V_{IN}/2+C₂V_{IN}/2+C₃V_{IN}.

The configuration of capacitors 316, 314, and 330 shown in FIG. 3 is referred to herein as a “combination series/parallel” configuration. This terminology applies to any combination of capacitors wherein at least two series coupled capacitors are coupled in parallel with at least one other capacitor. Although only three capacitors are shown in a combination series/parallel configuration in FIG. 3, this is not a limitation of the present invention. Many embodiments of the present invention exist with a wide variety of series/parallel combinations of capacitors.

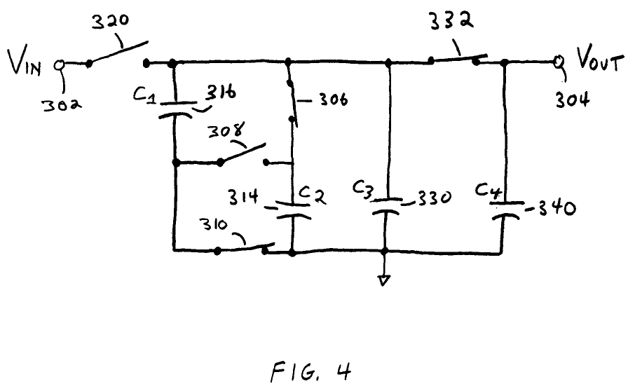

FIG. 4 shows a switched-capacitor converter in a step-down discharging phase. As shown in FIG. 4, each of the switches has been toggled to reconfigure capacitors 316, 314, and 330 from a combination series/parallel configuration to a parallel configuration. As described above with reference to FIG. 3, the total charge stored on capacitors 316, 314, and 330 after the charging phase is equal to Q_{TOTAL}=C₁V_{IN}/2+C₃V_{IN}. When the capacitors are reconfigured in parallel in the discharging phase, the resulting voltage on the parallel combination may be determined by V=Q_{TOTAL}/(C₁+C₂+C₃), or V=(C₁V_{IN}/2+C₂V_{IN}/2+(C₃V_{IN})/(C₁+C₂+C₃). During the discharging phase, the parallel combination of capacitors 316, 314 and 330 is placed in parallel with output capacitor 340 which accepts charge from the parallel capacitors 316, 314, and 330, and substantially maintains the output voltage V_{OUT} during the charging phase.

In some embodiments of the present invention, the switched-capacitor power converter alternates between the charging phase shown in FIG. 3 and the discharging phase shown in FIG. 4, and the output voltage is a “stepped-down” version of the input voltage. Table 1 shows the approximate resulting output voltage as a function of the capacitor values and input voltage.

TABLE 1
V_{OUT} versus capacitor values for V_{IN} = 3.0 V.

| | C₁ | C₂ | C₃ | |
|---|---|---|---|---|
| V_{IN} | (uF) | (uF) | (uF) | V_{OUT} |
| 3 | 0.05 | 0.05 | 0.001 | 1.51 |
| 3 | 0.05 | 0.05 | 0.0027 | 1.54 |
| 3 | 0.05 | 0.05 | 0.0033 | 1.55 |
| 3 | 0.05 | 0.05 | 0.005 | 1.57 |
| 3 | 0.05 | 0.05 | 0.0067 | 1.59 |
| 3 | 0.05 | 0.05 | 0.0075 | 1.60 |
| 3 | 0.05 | 0.05 | 0.01 | 1.64 |
| 3 | 0.05 | 0.05 | 0.027 | 1.82 |
| 3 | 0.05 | 0.05 | 0.033 | 1.87 |
| 3 | 0.05 | 0.05 | 0.05 | 2.00 |
| 3 | 0.05 | 0.05 | 0.067 | 2.10 |
| 3 | 0.05 | 0.05 | 0.075 | 2.14 |
| 3 | 0.05 | 0.05 | 0.1 | 2.25 |
| 3 | 0.05 | 0.05 | 0.27 | 2.59 |
| 3 | 0.05 | 0.05 | 0.33 | 2.65 |
| 3 | 0.05 | 0.05 | 0.5 | 2.75 |
| 3 | 0.05 | 0.05 | 0.67 | 2.81 |
| 3 | 0.05 | 0.05 | 0.75 | 2.82 |
| 3 | 0.05 | 0.05 | 1 | 2.86 |
| 3 | 0.05 | 0.05 | 10 | 2.99 |

Table 1 shows equal capacitance values for C₁ and C₂, although this is not a limitation of the present invention. For example, in some embodiments, C₁ and C₂, have different values, such as 0.05 uF and 0.1 uF. Also for example, some combinations of values for C₁ and C₂ allow the switched-capacitor circuit to output voltages less than half of the supply voltage. Each of the capacitors may take any capacitance value without departing from the scope of the present invention. Further, any number of capacitors having different capacitance values may be coupled in series similar to capacitors 316 and 314.

As shown in Table 1, the output voltage V_{OUT} may be a non-integer sub-multiple of the input voltage V_{IN}. The various capacitance values in the combination series/parallel configuration may be altered to produce any sub-multiple of the input voltage.

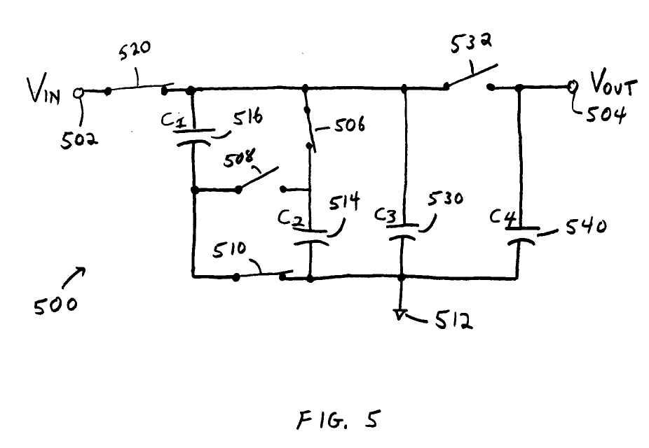

FIG. 5 shows a switched-capacitor converter in a step-up charging phase. Switched-capacitor power converter 500 includes capacitors 516, 514, 530, and 540, and switches 520, 506, 508, 510, and 532. During the charging phase shown in FIG. 5, capacitors 516, 514, and 530 are coupled in parallel between input node 502 and reference node 512, and each of capacitors 516, 514, and 530 charges to V_{IN}. Capacitor 540 is an output capacitor that is electrically isolated from the other capacitors by switch 532 during the charging phase.

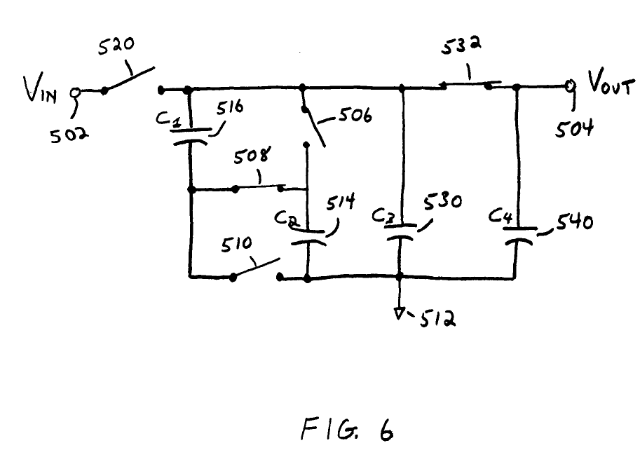

FIG. 6 shows a switched-capacitor converter in a step-up discharging phase. As shown in FIG. 6, each of the switches has been toggled to reconfigure capacitors 516, 514, and 530 from a parallel configuration to a combination series/parallel configuration. When the capacitors are reconfigured in the discharging phase, the resulting voltage on the series/parallel combination is larger than V_{IN} by an amount that is dependent, in part, on the capacitance values of capacitors 516, 514, and 530. During the discharging phase, the series/parallel combination of capacitors 516, 514, and 530 is placed in parallel with output capacitors 540 which substantially maintains the output voltage V_{OUT} during the charging phase.

Although only three capacitors are shown in a combination series/parallel configuration in FIG. 6, this is not a limitation of the present invention. Many embodiments of the present invention exist with a wide variety of series/parallel combinations of capacitors.

In some embodiments of the present invention, the switched-capacitor power convertor alternates between the charging phase shown in FIG. 5 and the discharging phase shown in FIG. 6, and the output voltage is a “stepped-up” version of the input voltage. Table 2 shows the resulting output voltage as a function of the capacitor values and input voltage.

TABLE 2
V_{OUT} versus capacitor values for V_{IN} = 3.0 V.

| | C₁ | C₂ | C₃ | |
|---|---|---|---|---|
| V_{IN} | (uF) | (uF) | (uF) | V_{OUT} |
| 3 | 0.05 | 0.05 | 0.001 | 5.88 |
| 3 | 0.05 | 0.05 | 0.0027 | 5.71 |
| 3 | 0.05 | 0.05 | 0.0033 | 5.65 |
| 3 | 0.05 | 0.05 | 0.005 | 5.50 |
| 3 | 0.05 | 0.05 | 0.0067 | 5.37 |
| 3 | 0.05 | 0.05 | 0.0075 | 5.31 |
| 3 | 0.05 | 0.05 | 0.01 | 5.14 |
| 3 | 0.05 | 0.05 | 0.027 | 4.44 |
| 3 | 0.05 | 0.05 | 0.033 | 4.29 |
| 3 | 0.05 | 0.05 | 0.05 | 4.00 |
| 3 | 0.05 | 0.05 | 0.067 | 3.82 |
| 3 | 0.05 | 0.05 | 0.075 | 3.75 |
| 3 | 0.05 | 0.05 | 0.1 | 3.60 |
| 3 | 0.05 | 0.05 | 0.27 | 3.25 |
| 3 | 0.05 | 0.05 | 0.33 | 3.21 |
| 3 | 0.05 | 0.05 | 0.5 | 3.14 |
| 3 | 0.05 | 0.05 | 0.67 | 3.11 |
| 3 | 0.05 | 0.05 | 0.75 | 3.10 |
| 3 | 0.05 | 0.05 | 1 | 3.07 |
| 3 | 0.05 | 0.05 | 10 | 3.01 |

Table 2 shows equal capacitance values for C₁ and C₂, although this is not a limitation of the present invention. For example, in some embodiments, C₁ and C₂, have different values, such as 0.05 uF and 0.1 uF. Each of the capacitors may take any capacitance value without departing from the scope of the present invention. Further, any number of capacitors having different capacitance values may be coupled in series similar to capacitors 316 and 314.

As shown in Table 2, the output voltage V_{OUT} may be a non-integer multiple of the input voltage V_{IN}. The various capacitance values in the series/parallel configuration may be altered to produce any multiple of the input voltage.

The switches shown in FIGS. 3-6 may be any type of device capable of coupling the various capacitive elements as shown. For example, switches can be implemented with isolated gate transistors such as metal oxide semiconductor field effect transistors (MOSFETs). Other types of switching elements may also be utilized for the various switches without departing from the scope of the present invention. For example, the switches of the foregoing figures may be implemented using junction field effect transistors (JFETs), bipolar junction transistors (BJTs), or any device capable of performing as described herein. Also for example, some of the switches may be implemented with diodes or other elements that allow current to flow in only one direction.

In some embodiments, switched-capacitance power converters include control circuits (not shown) to control the various switches. For example, a control circuit such as a finite state machine may toggle the switches of FIGS. 3 and 4, to alternate the switched-capacitor power converter between a step-down charging state and a step-down discharging state. Also for example, a control circuit may be included to toggle the switches of FIGS. 5 and 6 to alternate the switched-capacitor power converter between a step-up charging state and a step-up discharging state.

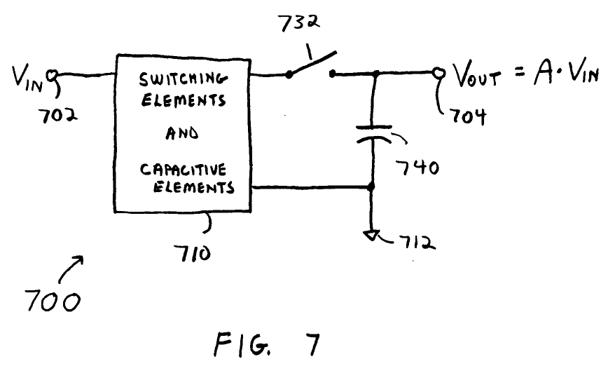

FIG. 7 shows a diagram of a switched-capacitor power converter. Switched-capacitor power converter 700 includes block 710, switch 732, and capacitor 740. Switched-capacitor power converter 700 receives an input voltage V_{IN} between input node 702 and reference node 712, and produces an output voltage V_{OUT} between output node 704 and reference node 712.

Block 710 includes switching elements and a plurality of configurable capacitive elements. In some embodiments, block 710 includes two capacitors that can be coupled in either series or parallel between input node 702 and reference node 712, or between output node 704 and reference node 712. In other embodiments, block 710 includes three or more capacitive elements that can be coupled in series or parallel between the input or output node and the reference node. Block 710 may also include any number of capacitive elements that can be coupled in parallel with the series combinations just described. Block 710 also includes switching elements. The switching elements of block 710 may be any type of switching element capable of coupling capacitors as previously described.

Block 710 may operate in a charging phase and a discharging phase as described above with reference to FIGS. 3-6. Block 710 may implement a step-down converter, or a step up converter. The output voltage V_{OUT} is related to the input voltage by a multiplier “A.” As shown in FIG. 7, V_{OUT}=AV_{IN}. The multiplier “A” may be more or less than one, and may be a non-integer value.

In some embodiments, the capacitive elements are coupled in a parallel configuration during the charging phase and are coupled in a combination series/parallel configuration during the discharging phase. In other embodiments, the capacitive elements are coupled in a combination series/parallel configuration during the charging phase and in a parallel configuration during the discharging phase. In still other embodiments, the capacitive elements are configured in a first combination series/parallel configuration during the charging phase, and in a second combination series/parallel configuration during the discharging phase.

Switched-capacitor power converter 700 also includes switch 732 and output capacitor 740. In some embodiments, output capacitor 740 is of sufficient size to substantially maintain the output voltage V_{OUT} while block 710 is in a charging phase. Switch 732 may electrically isolate output node 704 from block 710 during the charging phase, and connect output node 704 to block 710 during the discharging phase.

Switched-capacitor power converters, switches, capacitive elements, control circuits, and other embodiments of the present invention can be implemented in many ways. In some embodiments, they are implemented in integrated circuits as part of a power distribution network. In some embodiments, design descriptions of the various embodiments of the present invention are included in libraries that enable designers to include them in custom or semi-custom designs. For example, any of the disclosed embodiments can be implemented in a synthesizable hardware design language, such as VHDL or Verilog, and distributed to designers for inclusion in standard cell designs, gate arrays, or the like. Likewise, any embodiment of the present invention can also be represented as a hard macro targeted to a specific manufacturing process. For example, the switching elements within block 710 (FIG. 7) can be represented as polygons assigned to layers of an integrated circuit.

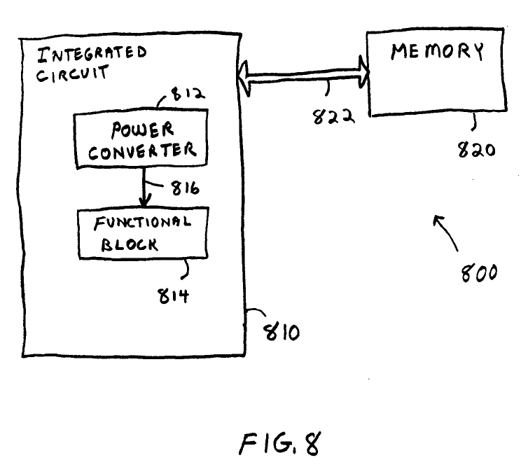

FIG. 8 shows a system diagram in accordance with various embodiments of the present invention. FIG. 8 shows system 800 including integrated circuits 810 and memory device 820. Integrated circuit 810 includes power converter 812 and functional block 814. Power converter 812 may be any of the switched-capacitor power converters described herein. In some embodiments, power converter 812 includes switching elements and control circuits, and capacitors are external to integrated circuit 810. In these embodiments, the output voltage presented on node 816 may be controlled by the selection of capacitors external to integrated circuit 810. In other embodiments, there may be on-chip control of capacitor ratios that allow digital selection of many possible output voltage levels.

Functional block 814 may be any type of functional block that can be included in integrated circuit 810. For example, in some embodiments, integrated circuit 810 includes a microprocessor, and functional block 814 includes an arithmetic logic unit (ALU). Integrated circuit 810 may include many more functional blocks, and power converter 812 may provide power to any number of the functional blocks.

Integrated circuit 810 may be any type of integrated circuit capable of including a switched-capacitor power converter as shown. For example, integrated circuit 810 may be a processor such as a microprocessor, a digital signal processor, a microcontroller, or the like. Integrated circuit 810 may also be an integrated circuit other than a processor such as an application-specific integrated circuit (ASIC), a communications device, a memory controller, or a memory such as a dynamic random access memory (DRAM). For ease of illustration, portions of integrated circuit 810 are not shown. Integrated circuit 810 may include much more circuitry than illustrated in FIG. 8 without departing from the scope of the present invention.

In some embodiments, memory device 820 may include a dynamic random access memory (DRAM) or a static random access memory (SRAM). Many other system-level uses exist for the switched-capacitor power converters described herein. For example, switched-capacitor power converters may be used in systems with FLASH memory, or in systems with no memory at all.

In some embodiments, integrated circuit 810 and memory device 820 may be separately packaged and mounted on a common circuit board. Each of integrated circuit 810 and memory device 820 may also be separately packaged and mounted on separate circuit boards interconnected by conductor 822. In other embodiments, integrated circuit 810 and memory device 820 are separate integrated circuit dice packaged together, such as in a multi-chip module, and in still further embodiments, integrated circuit 810 and memory device 820 are on the same integrated circuit die.

FIG. 8 shows one integrated circuit with a power converter and one memory device. In some embodiments, many more memory devices are included. Further, any number of power converters can be included. In other embodiments, integrated circuit types other than those shown in FIG. 8 are included in system 800.

Systems represented by the various foregoing figures can be of any type. Examples of represented systems include computers (e.g., desktops, laptops, handhelds, servers, tablets, web appliances, routers, etc.), wireless communications devices (e.g., cellular phones, cordless phones, pagers, personal digital assistants, etc.), computer-related peripherals (e.g., printers, scanners, monitors, etc.), entertainment devices (e.g., televisions, radios, stereos, tape and compact disc players, video cassette recorders, camcorders, digital cameras, MP3 (Motion Picture Experts Group, Audio Layer 3) players, video games, watches, etc.), and the like.

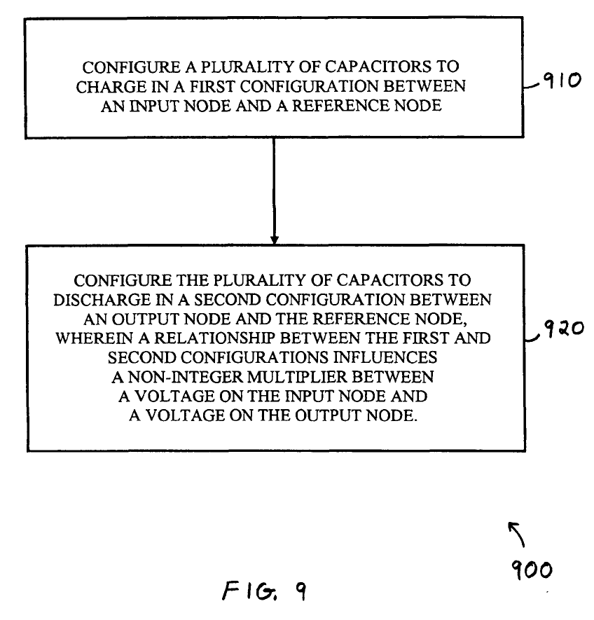

FIG. 9 shows a flowchart in accordance with various embodiments of the present invention. In some embodiments, method 900, or portions thereof, is performed by a switched-capacitor power converter, embodiments of which are shown in previous figures. In other embodiments, method 900 is performed by a control circuit, an integrated circuit, or an electronic system. Method 900 is not limited by the particular type of apparatus performing the method. The various actions in method 900 may be performed in the order presented, or may be performed in a different order. Further, in some embodiments, some actions listed in FIG. 9 are omitted from method 900.

Method 900 is shown beginning with block 910 in which a plurality of capacitors are configured to charge in a first configuration between an input node and a reference node. For example, the plurality of capacitors may be coupled in a parallel configuration or a combination series/parallel configuration. Any number of capacitors may be coupled in parallel, or any number of capacitors may be coupled in series. Examples of capacitors coupled in various configurations between an input node and a reference node are shown in FIGS. 3 and 5, although the present invention is not limited in this respect.

In block 920, the plurality of capacitors are configured to discharge in a second configuration between an output node and the reference node. A relationship exists between the first and second configurations that influences a non-integer multiplier between a voltage on the input node and a voltage on the output node. For example, in some embodiments, the first configuration includes a combination series/parallel configuration, and the second configuration includes a parallel configuration to produce a non-integer multiplier less than one. In some embodiments, this corresponds to a step-down converter as shown in FIGS. 3 and 4. Also for example, in some embodiments, the first configuration includes a parallel configuration, and the second configuration includes a combination series/parallel configuration to produce a non-integer multiplier more than one. In some embodiments, this corresponds to a step-up converter as shown in FIGS. 5 and 6.

Although the present invention has been described in conjunction with certain embodiments, it is to be understood that modifications and variations may be resorted to without departing from the spirit and scope of the invention as those skilled in the art readily understand. Such modifications and variations are considered to be within the scope of the invention and the appended claims.

What is claimed is:

1. A power converter comprising:
an input node, an output node, and a reference node;
a plurality of capacitive elements coupled between the input, output, and reference nodes; and
a plurality of switching elements to alternately configure the plurality of capacitive elements between a combination series/parallel configuration and a parallel configuration to provide a non-integer voltage division from the input node to the output node.

2. The power converter of claim 1 further comprising an output capacitor coupled between the output node and the reference node.

3. The power converter of claim 2 wherein the plurality of switching elements includes a switch coupled between the plurality of capacitive elements and the output capacitor.

4. The power converter of claim 1 wherein the plurality of switching elements are configured to couple at least one of the capacitive elements in parallel with a series combination of other capacitive elements between the input node and the reference node.

5. The power converter of claim 4 wherein the plurality of switching elements are also configured to couple the plurality of capacitive elements in parallel between the output node and the reference node.

6. The power converter of claim 4 wherein the series combination of other capacitors comprises two capacitors having different capacitance values.

7. A power converter comprising:
an output capacitor;
a plurality of configurable capacitors;
a first switching device to electrically isolate the plurality of configurable capacitors from the output capacitor; and
a plurality of switching devices to configure the plurality of configurable capacitors to charge in parallel or series/parallel when the first switching device is open, and to configure the plurality of capacitors to discharge in a parallel or series/parallel configuration when the first switching device is closed.

8. The power converter of claim 7 wherein the plurality of switching devices are coupled to charge the configurable capacitors in a series/parallel combination, and to discharge the configurable capacitors in parallel to effect a non-integer voltage division.

9. The power converter of claim 7 wherein the plurality of switching devices are coupled to charge the configurable capacitors in parallel, and to discharge the configurable capacitors in a series/parallel combination to effect a non-integer voltage multiplication.

10. The power converter of claim 7 wherein the plurality of switching devices are coupled to charge the configurable capacitors in a first series/parallel configuration, and to discharge the configurable capacitors in a second series/parallel configuration to effect a non-integer voltage change.

11. A circuit comprising a plurality of switches configured to couple a plurality of capacitors in parallel and series/parallel combinations between an input node and a reference node, and between an output node and the reference node.

12. The circuit of claim 11 wherein the plurality of switches are configured to couple the plurality of capacitors in a series/parallel combination between the input node and the reference node, and to couple the plurality of capacitors in parallel between the output node and the reference node.

13. The circuit of claim 11 wherein the plurality of switches are configured to couple the plurality of capacitors in parallel between the input node and the reference node, and to couple the plurality of capacitors in a series/parallel combination between the output node and the reference node.

14. The circuit of claim 111 wherein the plurality of switches are configured to couple the plurality of capacitors in a first series/parallel combination between the input node and the reference node, and to couple the plurality of capacitors in a second series/parallel combination between the output node and the reference node.

15. An electronic system comprising:
a first integrated circuit including a dynamic random access memory device; and
a second integrated circuit coupled to the first integrated circuit, the second integrated circuit including a power converter, the power converter including a plurality of switches configured to couple a plurality of capacitors in parallel and series/parallel combinations between an input node and a reference node, and between an output node and the reference node.

16. The electronic system of claim 15 wherein the plurality of switches are configured to couple the plurality of capacitors in a series/parallel combination between the input node and the reference node, and to couple plurality of capacitors in parallel between the output node and the reference node.

17. The electronic system of claim 15 wherein the plurality of switches are configured to couple the plurality of capacitors in parallel between the input node and the reference node, and to couple the plurality of capacitors in a series/parallel combination between the output node and the reference node.

18. A method comprising:
configuring a plurality of capacitors to charge in a first configuration between an input node and a reference node; and
configuring the plurality of capacitors to discharge in a second configuration between an output node and the reference node, wherein a relationship between the first and second configurations influences a non-integer multiplier between a voltage on the input node and a voltage on the output node.

19. The method of claim 18 wherein configuring a plurality of capacitors to charge comprises configuring the plurality of capacitors in series between the input node and the reference node, and wherein the non-integer multiplier is less than one.

20. The method of claim 18 wherein configuring a plurality of capacitors to charge comprises configuring the plurality of capacitors in a series/parallel combination between the input node and the reference node.

21. The method of claim 20 wherein the non-integer multiplier is less than one.

22. The method of claim 20 wherein the non-integer multiplier is more than one.

23. The method of claim 18 wherein configuring a plurality of capacitors to charge comprises configuring the plurality of capacitors in parallel between the input node and the reference node, and wherein the non-integer multiplier is more than one.
